(19) United States
(12) Patent Application Publication
(10) Pub. No.: US 2026/0177806 A1
(43) Pub. Date: Jun. 25, 2026

(54) VR EYEPIECE SYSTEM

(71) Applicant: ZHEJIANG SUNNY OPTICS CO., LTD., Yuyao City (CN)

(72) Inventors: Huan LIU, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/271,486

(22) Filed: Jul. 16, 2025

(30) Foreign Application Priority Data
Dec. 25, 2024 (CN) 202411920016.4

(51) Int. Cl. G02B 25/00; G02B 1/08; G02B 27/01

(52) U.S. Cl. CPC G02B 25/001; G02B 1/08; G02B 27/0172; G02B 2027/0123

(57) ABSTRACT

The disclosure relates to a VR eyepiece system. The VR eyepiece system includes: a lens assembly, which includes a first lens, a second lens, a third lens and a fourth lens that are coaxially arranged in sequence from an eye side to an image side; a quarter-wave plate, which is attached to an image-side surface of a polarizing reflective film; a transflective film, which is attached to an image-side surface of the third lens; and a display assembly, which is arranged on an image-side surface of the fourth lens. The VR eyepiece system satisfies: 1.35<TTL·tan (SEMI-FOV)/IMGh<1.6, TTL is an on-axis distance from an eye-side surface of the first lens to the display assembly, SEMI-FOV is a semi-field of view of the VR eyepiece system, and IMGh is a half of a diagonal length of an effective pixel region on an imaging surface of the VR eyepiece system.

### CROSS-REFERENCE TO RELATED APPLICATION

The disclosure claims the priority to Chinese Patent Application No. 202411920016.4, filed with the China National Intellectual Property Administration (CNIPA) on Dec. 25, 2024, which is hereby incorporated by reference in its entirety.

### TECHNICAL FIELD

The disclosure relates to the technical field of VR devices, and in particular to a VR eyepiece system.

### BACKGROUND

Users have benefited from the rapid development of virtual reality (VR) technology in various ways. With the VR technology, the users are able to enjoy immersive experience of a virtual world, and revolutionary changes are able to be made to fields such as education, entertainment and training. The VR technology has been widely applied to gaming, virtual tourism, healthcare, architectural design, and other fields, demonstrating a huge business potential in the market.

Currently available VR devices still fall short of imaging quality and visual experience, and are unable to satisfy demand of users for a high-quality virtual experience.

### SUMMARY

In view of this, it is necessary to provide a virtual reality (VR) eyepiece system for solving a problem that imaging quality and visual experience of VR devices are poor and cannot satisfy demand of users.

Some embodiments of the disclosure provide a VR eyepiece system, including:
a lens assembly, the lens assembly includes a first lens, a second lens, a third lens, and a fourth lens that are coaxially arranged in sequence from an eye side to an image side, an image-side surface of the first lens is a flat surface, and an eye-side surface and the image-side surface of the first lens are spherical surfaces; an image-side surface of the second lens is a convex surface, and an eye-side surface and the image-side surface of the second lens are spherical surfaces; the third lens has a negative refractive power, an eye-side surface and an image-side surface of the third lens are a concave surface and a convex surface respectively, and the eye-side surface and the image-side surface of the third lens are aspheric surfaces; and an eye-side surface and an image-side surface of the fourth lens are aspheric surfaces;
a polarizing reflective film, the polarizing reflective film is attached to the image-side surface of the first lens;
a quarter-wave plate, the quarter-wave plate is attached to an image-side surface of the polarizing reflective film;
a transflective film, the transflective film is attached to the image-side surface of the third lens; and
a display assembly, the display assembly is arranged on the image-side surface of the fourth lens;
the VR eyepiece system satisfies the following conditional expression:

$$1. 35 < TTL \cdot tan ( SEMI - FOV ) / IMGh < 1.6 ;$$

TTL is an on-axis distance from the eye-side surface of the first lens to the display assembly, SEMI-FOV is a semi-field of view of the VR eyepiece system, and IMGh is a half of a diagonal length of an effective pixel region on an imaging surface of the VR eyepiece system.

In some embodiments, the VR eyepiece system satisfies the following conditional expression:

$$1.35 < f / IMGh < 1.5 ;$$

f is an effective focal length of the VR eyepiece system, and IMGh is the half of the diagonal length of the effective pixel region on the imaging surface of the VR eyepiece system.

In some embodiments, the VR eyepiece system satisfies the following conditional expression:

$$- 2 < f 1 / f 2 < 2.5 ;$$

f1 is an effective focal length of the first lens, and f2 is an effective focal length of the second lens.

In some embodiments, the VR eyepiece system satisfies the following conditional expression:

$$- 1 < f 3 / f 4 < 1.4 ;$$

f3 is an effective focal length of the third lens, and f4 is an effective focal length of the fourth lens.

In some embodiments, the lens assembly further includes a glue layer having a refractive index, and the glue layer is arranged between the second lens and the third lens, so as to glue the second lens and the third lens together.

In some embodiments, the VR eyepiece system satisfies the following conditional expression:
N polarizing reflective film RP=N quarter-wave plate QWP=Ng;
N polarizing reflective film RP is a refractive index of the polarizing reflective film, N quarter-wave plate QWP is a refractive index of the quarter-wave plate, and Ng is the refractive index of the glue layer.

In some embodiments, the VR eyepiece system satisfies the following conditional expression:

$$1.9 \leq V 2 / V 3 < 2.6 ;$$

V2 is an Abbe number of the second lens, and V3 is an Abbe number of the third lens.

In some embodiments, the VR eyepiece system satisfies the following conditional expression:

$$2.1 < ( CT 2 + CTg + CT 3 ) / CT 1 < 5.6 ;$$

CT1 is a center thickness of the first lens, CT2 is a center thickness of the second lens, CTg is a center thickness of the glue layer, and CT3 is a center thickness of the third lens.

In some embodiments, the VR eyepiece system satisfies the following conditional expression:

$$0.6 < ( CT 4 \cdot N 4 ) / BFL < 3.7 ;$$

CT4 is a center thickness of the fourth lens, N4 is a refractive index of the fourth lens, and
BFL is an on-axis distance from the image-side surface of the fourth lens to a display screen.

In some embodiments, the VR eyepiece system satisfies the following conditional expression:

$$3.3 < FNO / TAN ( SEMI - FOV ) < 4.1 ;$$

SEMI-FOV is the semi-field of view of the VR eyepiece system, and FNO is a numerical aperture of the VR eyepiece system.

In some embodiments, the VR eyepiece system satisfies the following conditional expression:

$$0.75 < IMGh / DT 42 < 0 \text{.95} ;$$

IMGh is the half of the diagonal length of the effective pixel region on the imaging surface of the VR eyepiece system, and DT42 is an effective radius of the image-side surface of the fourth lens.

In some embodiments, the VR eyepiece system satisfies the following conditional expression:

$$2.7 < DT 11 / EPD < 3.3 ;$$

DT11 is an effective radius of the eye-side surface of the first lens, and EPD is an entrance pupil diameter of the VR eyepiece system.

In some embodiments, the VR eyepiece system satisfies the following conditional expression:

$$1.1 \leq TD / ED < 1.35 ;$$

TD is an on-axis distance from the eye-side surface of the first lens to the image-side surface of the fourth lens, and ED is an on-axis distance from an eye to the eye-side surface of the first lens.

The VR eyepiece system in the disclosure is able to optimize imaging quality by designing ratio relations among a plurality of key parameters, so as to provide a comfortable visual experience and reduce eye fatigue of a user in long-time use.

According to the VR eyepiece system in the disclosure, the polarizing reflective film and the quarter-wave plate are attached to the image-side surface of the first lens, such that a propagation direction and a polarization state of light are controlled favorably, a display effect is improved, and a glare is reduced, meanwhile, a total length of an optical system is able to be reduced, and a size and mass of the VR eyepiece system are able to be reduced.

### BRIEF DESCRIPTION OF THE DRAWINGS

FIG. 1A shows a schematic diagram of an optical path of a VR eyepiece system according to Embodiment 1 of the disclosure;

FIG. 1B shows a longitudinal aberration curve of a VR eyepiece system according to Embodiment 1 of the disclosure;

FIG. 1C shows an astigmatism curve of a VR eyepiece system according to Embodiment 1 of the disclosure;

FIG. 1D shows a distortion curve of a VR eyepiece system according to Embodiment 1 of the disclosure;

FIG. 1E shows a modulation transfer function (MTF) diagram of a VR eyepiece system according to Embodiment 1 of the disclosure;

FIG. 2A shows a schematic diagram of an optical path of a VR eyepiece system according to Embodiment 2 of the disclosure;

FIG. 2B shows a longitudinal aberration curve of a VR eyepiece system according to Embodiment 2 of the disclosure;

FIG. 2C shows an astigmatism curve of a VR eyepiece system according to Embodiment 2 of the disclosure;

FIG. 2D shows a distortion curve of a VR eyepiece system according to Embodiment 2 of the disclosure;

FIG. 2E shows an MTF diagram of a VR eyepiece system according to Embodiment 2 of the disclosure;

FIG. 3A shows a schematic diagram of an optical path of a VR eyepiece system according to Embodiment 3 of the disclosure;

FIG. 3B shows a longitudinal aberration curve of a VR eyepiece system according to Embodiment 3 of the disclosure;

FIG. 3C shows an astigmatism curve of a VR eyepiece system according to Embodiment 3 of the disclosure;

FIG. 3D shows a distortion curve of a VR eyepiece system according to Embodiment 3 of the disclosure;

FIG. 3E shows an MTF diagram of a VR eyepiece system according to Embodiment 3 of the disclosure;

FIG. 4A shows a schematic diagram of an optical path of a VR eyepiece system according to Embodiment 4 of the disclosure;

FIG. 4B shows a longitudinal aberration curve of a VR eyepiece system according to Embodiment 4 of the disclosure;

FIG. 4C shows an astigmatism curve of a VR eyepiece system according to Embodiment 4 of the disclosure;

FIG. 4D shows a distortion curve of a VR eyepiece system according to Embodiment 4 of the disclosure;

FIG. 4E shows an MTF diagram of a VR eyepiece system according to Embodiment 4 of the disclosure;

FIG. 5A shows a schematic diagram of an optical path of a VR eyepiece system according to Embodiment 5 of the disclosure;

FIG. 5B shows a longitudinal aberration curve of a VR eyepiece system according to Embodiment 5 of the disclosure;

FIG. 5C shows an astigmatism curve of a VR eyepiece system according to Embodiment 5 of the disclosure;

FIG. 5D shows a distortion curve of a VR eyepiece system according to Embodiment 5 of the disclosure; and

FIG. 5E shows an MTF diagram of a VR eyepiece system according to Embodiment 5 of the disclosure.

### DETAILED DESCRIPTION OF THE EMBODIMENTS

In order to make the above objectives, features, and advantages of the disclosure clearer and more understandable, the particular embodiments of the disclosure will be described in detail below in conjunction with the accompanying drawings. Various specific details are set forth in the following description to facilitate thorough understanding of the disclosure. However, the disclosure can be implemented in many other ways than those described herein, and those skilled in the art can make similar improvements without departing from the essence of the disclosure. Therefore, the disclosure is not limited by specific embodiments disclosed below.

In the description of the disclosure, it should be understood that the orientation or position relations indicated by the terms “center”, “longitudinal”, “transverse”, “length”, “width”, “thickness”, “up”, “down”, “front”, “rear”, “left”, “right” “vertical”, “horizontal”, “top”, “bottom”, “inside”, “outside”, “clockwise”, “counterclockwise”, “axial”, “radial”, “circumferential”, etc. are based on the orientation or position relations shown in the accompanying drawings, are merely for facilitating the description of the disclosure and simplifying the description, rather than indicating or implying that the device or element referred to must have a particular orientation or be constructed and operated in a particular orientation, and therefore cannot be interpreted as limiting the disclosure.

Moreover, the terms “first” and “second” are merely for description and cannot be interpreted as indicating or implying relative importance or implicitly indicating the number of technical features indicated. Therefore, the features defined with “first” and “second” can explicitly or implicitly include at least one feature. In the description of the disclosure, “a plurality of” means at least two, such as two or three unless definitely and specifically limited otherwise.

In the disclosure, unless otherwise explicitly specified and limited, the terms such as “mount”, “connect”, “connection”, and “fix” should be understood in a broad sense. For example, unless otherwise explicitly limited, “connect” can denote a fixed connection, a detachable connection, an integrated connection, a mechanical connection, an electric connection, a direct connection, an indirect connection via an intermediate medium, communication inside two elements, or an interaction relation of two elements. For those of ordinary skill in the art, the specific meanings of the above terms in the present invention can be understood according to specific circumstances.

In the disclosure, a first feature is “on” or “underneath” a second feature can indicate that the first feature and the second feature are in direct contact or in indirect contact through an intermediate medium unless definitely specified and limited otherwise. Moreover, the first feature is “on”, “above”, and “over” the second feature can indicate that the first feature is exactly above the second feature or not, or merely indicates that the first feature has a higher level than the second feature. The first feature is “underneath”, “below”, and “under” the second feature can indicate that the first feature is exactly below the second feature or not, or merely indicates that the first feature has a lower level than the second feature.

It should be noted that when expressed as being “fixed to” or “arranged on” another element, an element can be directly on another element or an intervening element can also be arranged. When deemed as being “connected to” another element, an element can be directly connected to another element or an intervening element may be arranged simultaneously. As used in the disclosure, the terms “perpendicular”, “horizontal”, “up”, “down”, “left”, “right”, etc. are merely for illustration and do not indicate the uniqueness of the embodiment.

In view of this, in order to improve imaging quality and visual experience of virtual reality (VR) devices, the disclosure provides a VR eyepiece system. The VR eyepiece system considers ratio relations among a plurality of key parameters in optical design, so as to optimize imaging quality and improve a visual experience.

In particular, the VR eyepiece system of the disclosure includes: a lens assembly, a polarizing reflective film, a quarter-wave plate, a transflective film, and a display assembly. The lens assembly includes a first lens, a second lens, a third lens, and a fourth lens that are coaxially arranged in sequence from an eye side to an image side. An image-side surface of the first lens is a flat surface, and an eye-side surface and the image-side surface of the first lens are spherical surfaces. An image-side surface of the second lens is a convex surface, and an eye-side surface and the image-side surface of the second lens are spherical surfaces. The third lens has a negative refractive power, an eye-side surface and an image-side surface of the third lens are a concave surface and a convex surface respectively, and the eye-side surface and the image-side surface of the third lens are aspheric surfaces. An eye-side surface and an image-side surface of the fourth lens are aspheric surfaces. The polarizing reflective film is attached to the first lens and is configured for transmitting P light and reflecting S light, or transmitting S light and reflecting P light. The quarter-wave plate is attached to an image-side surface of the polarizing reflective film. The transflective film is attached to the image-side surface of the third lens. The display assembly is arranged on an image side of the fourth lens and is configured for emitting circularly polarized light.

It can be understood that the circularly polarized light emitted by the display assembly passes through the fourth lens, and passes through the transflective film on the image-side surface of the third lens, loses half of energy during passing through the third lens and the fourth lens, and then is converted into linearly polarized light (P light or S light) after passing through the quarter-wave plate on the image-side surface of the first lens, and the linearly polarized light is reflected after reaching the polarizing reflective film, passes through the second lens and the third lens again, and after reaching the transflective film on the image-side surface of the third lens, a part of light is reflected and enters eyes after passing through the third lens, the second lens, the quarter-wave plate, the polarizing reflective film and the first lens in sequence. In this way, the polarizing reflective film and the quarter-wave plate are attached to the image-side surface of the first lens, such that a propagation direction and a polarization state of light are controlled favorably, a display effect is improved, and a glare is reduced. Furthermore, a total length of an optical system is able to be reduced, and a size and mass of the VR eyepiece system are able to be reduced. In summary, the VR eyepiece system in the disclosure achieves a high-quality optical performance and a comfortable visual experience through elaborately designed lens configuration and surface treatment, providing an immersive virtual reality experience for users.

The VR eyepiece system in the disclosure satisfies the following conditional expression: 1.35<TTL·tan(SEMI-FOV)/IMGh<1.6. TTL is an on-axis distance from the eye-side surface of the first lens to the display assembly, SEMI-FOV is a semi-field of view of the VR eyepiece system, and IMGh is a half of a diagonal length of an effective pixel region on an imaging surface of the VR eyepiece system. The VR eyepiece system is designed according to the conditional expression, such that a propagation path and a display effect of light in the lens assembly are able to be guaranteed within a range, and it is guaranteed that the users are able to obtain a more realistic and comfortable virtual reality experience.

In some embodiments, the VR eyepiece system in the disclosure satisfies the following conditional expression: 1.35<f/IMGh<1.5, wherein f is an effective focal length of the VR eyepiece system, and IMGh is the half of the diagonal length of the effective pixel region on the imaging surface of the VR eyepiece system. The VR eyepiece system is designed according to the conditional expression, such that a limitation of a focal length and a pixel region size in optical system design is able to be achieved. By controlling parameters of the VR eyepiece system within the above range, an image clarity is able to be improved, and an eye fatigue of the users is able to be reduced. In this way, a better visual experience is able to be provided for the users, and the users are able to obtain clearer and more comfortable image effects when using a VR device. A relationship between the focal length and the pixel region size is able to be effectively balanced, thus improving performance of the entire system and a user experience.

In some embodiments, the VR eyepiece system in the disclosure satisfies the following conditional expression: −2<f1/f2<2.5, wherein f1 is an effective focal length of the first lens, and f2 is an effective focal length of the second lens. The VR eyepiece system is designed according to the conditional expression. By controlling a focal length ratio of the first lens to the second lens, the imaging quality is able to be improved, a focusing ability for light is able to be enhanced, and a distortion is able to be reduced, such that the performance of the optical system is able to be optimized.

In some embodiments, the VR eyepiece system in the disclosure satisfies the following conditional expression: −1<f3/f4<1.4, wherein f3 is an effective focal length of the third lens, and f4 is an effective focal length of the fourth lens. The VR eyepiece system is designed according to the conditional expression. By controlling a focal length ratio of the third lens to the fourth lens, the imaging quality is able to be improved, the focusing ability for light is able to be enhanced, and the distortion is able to be reduced, such that the performance of the optical system is able to be optimized.

In some embodiments, the lens assembly further includes a glue layer having a refractive index. The glue layer is arranged between the second lens and the third lens, so as to glue the second lens and the third lens together. In other words, the second lens and the third lens adopt a glued structure, so that a total reflection and scattering caused by air gaps between lenses are able to be avoided. An achromatic lens group is able to be composed for correcting a chromatic aberration by adjusting a refractive index between the second lens and the third lens. Moreover, by integrating the second lens and the third lens, an integral structure is formed, a stability and durability of the system are able to be improved, and a long-term stable operation of the system is able to be guaranteed. An assembly process is also simplified, a consistency of system performance is maintained, and a cost is reduced.

In some embodiments, the quarter-wave plate, the polarizing reflective film, and the glue layer all have a certain thickness. The quarter-wave plate is able to precisely control a phase of light waves, such that light passing through the quarter-wave plate generates a specific polarization state change, and an interference and stray light in an image are able to be reduced. The polarizing reflective film is able to selectively absorb or reflect light waves in specific directions, improving a polarization efficiency of light, thereby enhancing a contrast and clarity of the images. By accurately controlling thicknesses of the quarter-wave plate, the polarizing reflective film and the glue layer, film application and gluing difficulty are able to be reduced, a structural strength of the lens assembly is able to be enhanced, and the stability of the system is able to be improved.

In some embodiments, the VR eyepiece system in the disclosure satisfies the following conditional expression: N polarizing reflective film RP=N quarter-wave plate QWP=Ng. N polarizing reflective film RP is a refractive index of the polarizing reflective film, N quarter-wave plate QWP is a refractive index of the quarter-wave plate, and Ng is the refractive index of the glue layer. By controlling the refractive index of the polarizing reflective film to be equal to the refractive index of the quarter-wave plate, reflectivity between film layers is able to be reduced. By controlling the refractive index of the glue layer, the refractive index of the polarizing reflective film and the refractive index of the quarter-wave plate to be equal to one another, reflectivity between the second lens and the third lens is able to be avoided, and a purpose of reducing a ghost image of light deficiency is able to be achieved.

In some embodiments, the VR eyepiece system in the disclosure satisfies the following conditional expression: 1.9≤V2/V3<2.6. V2 is an Abbe number of the second lens, and V3 is an Abbe number of the third lens. The VR eyepiece system is designed according to the conditional expression, such that imaging of a lens combination composed of the second lens and the third lens is more consistent under different wavelengths. In a given V2/V3 range, the lens combination is able to have a better chromatic aberration correction effect. Through lens gluing, an aberration and a chromatic aberration are able to be reduced, and a clarity of an image is able to be improved accordingly.

In some embodiments, the VR eyepiece system in the disclosure satisfies the following conditional expression: 2.1<(CT2+CTg+CT3)/CT1<5.6. CT1 is a center thickness of the first lens, CT2 is a center thickness of the second lens, CTg is a center thickness of the glue layer, and CT3 is a center thickness of the third lens. The VR eyepiece system is designed according to the conditional expression, such that a total thickness and size of VR lenses are able to be controlled, a lighter and portable head-mounted device is able to be designed favorably, and convenience of carrying and wearing by users is able to be improved. By controlling the center thickness, a difficulty and cost of a film application process are able to be reduced, and the performance of the optical system after film application is able to be guaranteed.

In some embodiments, the VR eyepiece system in the disclosure satisfies the following conditional expression: 0.6<(CT4·N4)/BFL<3.7. CT4 is a center thickness of the fourth lens, N4 is a refractive index of the fourth lens, and BFL is an on-axis distance from the image-side surface of the fourth lens to a display screen. The VR eyepiece system is designed according to the conditional expression. By controlling a ratio among CT4, the center thickness and N4, the refractive index of the fourth lens and BFL, the back focal length from the image-side surface of the fourth lens to the display screen between 0.6 and 3.7, the design of the optical system is able to be optimized to guarantee that the propagation and focusing effects of light in the fourth lens fall within reasonable ranges.

In some embodiments, a ratio of FNO, a numerical aperture to SEMI-FOV, the semi-field of view of the VR eyepiece system reflects propagation and collection efficiency of light. For a virtual reality system, a range of this ratio influences light transmission performance and image quality of the system. The VR eyepiece system in the disclosure satisfies the following conditional expression: 3.3<FNO/TAN(SEMI-FOV)<4.1. SEMI-FOV is the semi-field of view of the VR eyepiece system, and FNO is a numerical aperture of the VR eyepiece system. The VR eyepiece system is designed according to the conditional expression. Transmittance performance and image quality of the system are able to be improved through the ratio of FNO, the numerical aperture to SEMI-FOV, the semi-field of view of the VR eyepiece system being between 3.3 and 4.1.

In some embodiments, by comprehensively considering the above conditional expressions, the VR eyepiece system in the disclosure needs to consider a ratio of the pixel region size to the effective radius of the fourth lens in design of the fourth lens. The VR eyepiece system in the disclosure satisfies the following conditional expression: 0.75<IMGh/DT42<0.95. IMGh is the half of the diagonal length of the effective pixel region on the imaging surface of the VR eyepiece system, and DT42 is an effective radius of the image-side surface of the fourth lens. By reasonably controlling the ratio, pixel resolution and image quality of the system are able to be optimized, and the visual experience of the users in a virtual reality environment is able to be improved.

In some embodiments, the VR eyepiece system in the disclosure needs to be designed to achieve an appropriate ratio of the effective radius of the eye-side surface of the first lens to the entrance pupil diameter. The VR eyepiece system in the disclosure satisfies the following conditional expression: 2.7<DT11/EPD<3.3. DT11 is an effective radius of the eye-side surface of the first lens, and EPD is an entrance pupil diameter of the VR eyepiece system. By reasonably controlling the ratio, the optical performance of the system is able to be optimized to improve clarity and fidelity of the image, and a virtual reality experience of users is able to be enhanced.

In some embodiments, the VR eyepiece system in the disclosure needs to consider a ratio of an on-axis distance from the eye-side surface of the first lens to the image-side surface of the fourth lens to an on-axis distance from the eye to the eye-side surface of the first lens during designing. For a virtual reality system, a range of the ratio influences the visual comfort and experience of the users. The VR eyepiece system in the disclosure satisfies the following conditional expression: 1.1≤TD/ED<1.35. TD is an on-axis distance from the eye-side surface of the first lens to the image-side surface of the fourth lens, and ED is an on-axis distance from an eye to the eye-side surface of the first lens. The VR eyepiece system is design according to the conditional expression. By controlling the on-axis distance from the eye-side surface of the first lens to the image-side surface of the fourth lens within a range, on one hand, it is ensured that the total optical length will not be too large, and the size and weight of the VR system are avoided being too large; and the total length will not to be too small, and performance requirements of the optical system are able to be satisfied. On the other hand, by controlling the on-axis distance from the eye to the eye-side surface of the first lens within a range and requiring the ratio of TD, the on-axis distance from the eye-side surface of the first lens to the image-side surface of the fourth lens to ED, the on-axis distance from eye to the eye-side surface of the first lens to be 1.1, the optical design of the system is able to be optimized, the fidelity of the image and the comfort of the user is able to be improved, and the virtual reality experience is able to be enhanced.

Specific embodiments of the VR eyepiece system applicable to the embodiments described above are further described below with reference to the accompanying drawings.

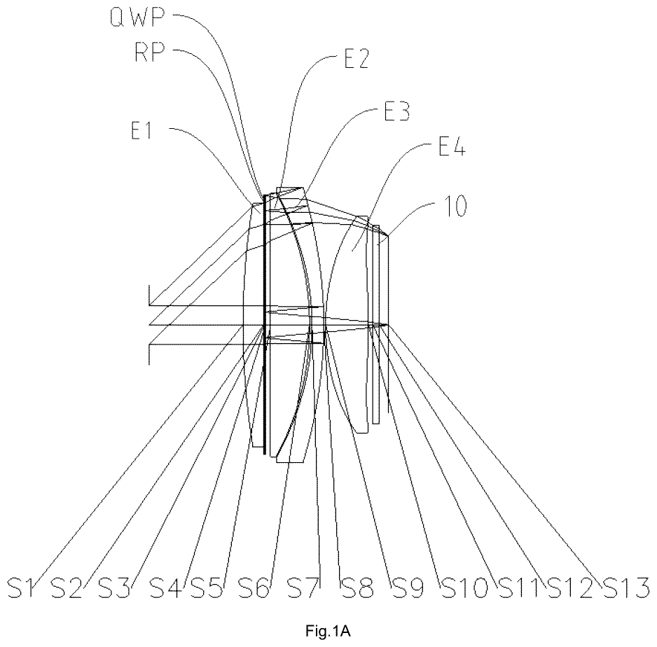

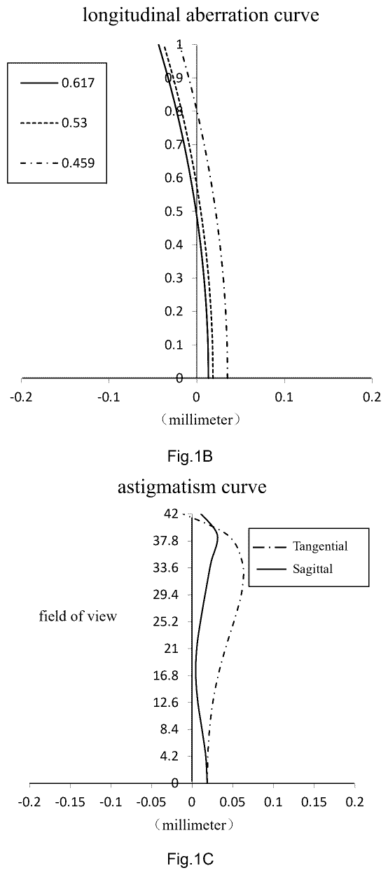

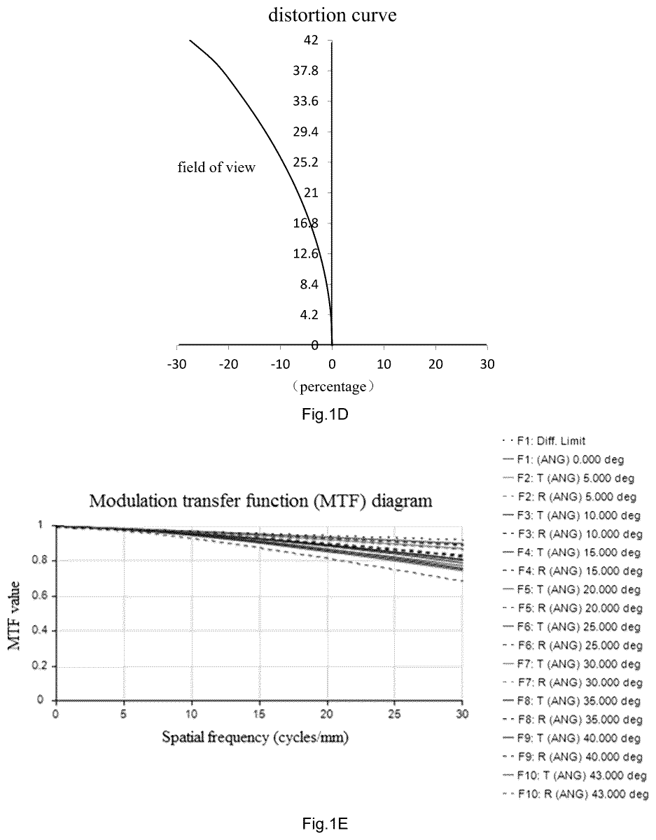

As shown in FIG. 1A, in Embodiment 1 of the disclosure, an optical camera lens includes a lens assembly, a polarizing reflective film RP, a quarter-wave plate QWP, a transflective film, and a display assembly 10. The lens assembly includes a first lens E1, a second lens E2, a third lens E3, and a fourth lens E4 that are coaxially arranged in sequence from an eye side to an image side. The polarizing reflective film RP is attached to the first lens E1. The quarter-wave plate QWP is attached to an image-side surface of the polarizing reflective film. The transflective film is attached to the third lens E3. The display assembly 10 is arranged on an image side of the fourth lens E4.

An eye-side surface and an image-side surface of the first lens E1 are a convex surface and a flat surface respectively, and the eye-side surface and the image-side surface of the first lens E1 are spherical surfaces. An eye-side surface and an image-side surface of the second lens E2 are a flat surface and a convex surface respectively, and the eye-side surface and the image-side surface of the second lens E2 are spherical surfaces. The third lens E3 has a negative refractive power, an eye-side surface and an image-side surface of the third lens E3 are a concave surface and a convex surface respectively, and the eye-side surface and the image-side surface of the third lens E3 are aspheric surfaces. An eye-side surface and an image-side surface of the fourth lens E4 are convex surfaces, and the eye-side surface and the image-side surface of the fourth lens E4 are aspheric surfaces.

Table 1 is a table of basic parameters of the lenses of the VR eyepiece system of Embodiment 1. The units of radius of curvature and thickness are millimeter (mm).

TABLE 1
table of basic parameters of lenses of VR eyepiece system of Embodiment 1

| | | | | | | | | | | | Quadric |
|---|---|---|---|---|---|---|---|---|---|---|---|
| Surface | Surface | | Radius of | | | | | | Refraction | Effective | constant |
| number | type | | curvature | | Thickness | | Material | | mode | radius | K |
| | Spherical | | Infinite | | 10.0000 | | | | Refraction | 2.0000 | |
| S1 | Spherical | R1 | 75.8288 | CT1 | 2.2000 | N1V1 | 1.85 | 23.60 | Refraction | 12.2547 | |
| S2 | Spherical | R2 | Infinite | | 0.1100 | | 1.50 | 57.00 | Refraction | 12.5974 | |
| S3 | Spherical | | Infinite | | 0.1100 | | 1.50 | 57.00 | Refraction | 12.6370 | |
| S4 | Spherical | | Infinite | | 0.5130 | | | | Refraction | 12.6766 | |
| S5 | Spherical | R3 | Infinite | CT2 | 4.1511 | N2V2 | 1.53 | 66.30 | Refraction | 12.9800 | |
| S6 | Spherical | R4 | −27.9206 | | 0.2555 | | 1.50 | 57.00 | Refraction | 13.2627 | |
| S7 | Aspheric | R5 | −25.5248 | CT3 | 1.2500 | N3V3 | 1.82 | 26.05 | Refraction | 13.2926 | 0.5348 |
| S8 | Aspheric | R6 | −44.8396 | | −1.2500 | | 1.82 | 26.05 | Reflection | 14.2737 | −1.4058 |
| S7 | Aspheric | R5 | −25.5248 | | −0.2555 | | 1.50 | 57.00 | Refraction | 13.2926 | 0.5348 |
| S6 | Spherical | R4 | −27.9206 | | −4.1511 | | 1.53 | 66.30 | Refraction | 13.2627 | |
| S5 | Spherical | R3 | Infinite | | −0.5130 | | | | Refraction | 12.9800 | |
| S4 | Spherical | | Infinite | | −0.1100 | | 1.50 | 57.00 | Refraction | 12.6766 | |
| S3 | Spherical | | Infinite | | 0.1100 | | 1.50 | 57.00 | Reflection | 12.6370 | |
| S4 | Spherical | | Infinite | | 0.5130 | | | | Refraction | 12.6766 | |
| S5 | Spherical | R3 | Infinite | CT2 | 4.1511 | | 1.53 | 66.30 | Refraction | 12.9800 | |
| S6 | Spherical | R4 | −27.9206 | | 0.2555 | | 1.50 | 57.00 | Refraction | 13.2627 | |
| S7 | Aspheric | R5 | −25.5248 | CT3 | 1.2500 | | 1.82 | 26.05 | | 13.2926 | 0.5348 |
| S8 | Aspheric | R6 | −44.8396 | | 0.1994 | | | | Refraction | 14.2737 | −1.4058 |
| S9 | Aspheric | R7 | 22.8133 | CT4 | 4.5476 | N4V4 | 1.61 | 60.40 | Refraction | 11.2431 | −2.1321 |
| S10 | Aspheric | R8 | −61.2396 | | 0.4661 | | | | Refraction | 10.6792 | −3.1264 |
| S11 | Spherical | | Infinite | | 0.7000 | | 1.52 | 64.17 | Refraction | 10.2752 | |
| S12 | Spherical | | Infinite | | 0.9972 | | | | Refraction | 9.9579 | |
| S13 | Spherical | | Infinite | | 0.0000 | | | | Refraction | 9.1604 | |

In Embodiment 1, the eye-side surfaces and the image-side surfaces of the third lens E3 and the fourth lens E4 are aspheric surfaces, and a surface type x of each aspheric lens may be defined by the following aspheric formula, which is not restrictive:

$$x = \frac{{ch}^{2}}{1 + \sqrt{1 - ( k + 1 ) {c}^{2} {h}^{2}}} + \sum {Aih}^{i}$$

Wherein, x is a vector height of a distance between the aspheric surface and a vertex of the aspheric surface when the aspheric surface is located at a position with the height h in the optical axis direction; c is a paraxial curvature of the aspheric surface, c=1/R (that is, that is, the paraxial curvature c is a reciprocal of radius of curvature R in Table 1 above; k is a conic coefficient; and Ai is a correction coefficient of the i-th order of the aspheric surface. Table 2 shows high-order term coefficients A4, A6, and A8 that may be used for each of the aspheric lens surfaces S7-S10 in Embodiment 1.

TABLE 2
table of conic coefficients of aspheric lens surfaces
of VR eyepiece system of Embodiment 1

| Surface number | A4 | A6 | A8 |
|---|---|---|---|
| S7 | 8.427E−06 | 2.123E−08 | 2.343E−11 |
| S8 | 1.101E−06 | −7.645E−10 | 2.372E−12 |
| S9 | 2.517E−05 | 1.674E−07 | −7.384E−11 |
| S10 | 8.126E−05 | −3.861E−09 | −1.005E−09 |

FIG. 1B shows a longitudinal aberration curve of the VR eyepiece system according to Embodiment 1. FIG. 1C shows an astigmatism curve of the VR eyepiece system according to Embodiment 1. FIG. 1D shows a distortion curve of the VR eyepiece system according to Embodiment 1. FIG. 1E shows a modulation transfer function (MTF) diagram of the VR eyepiece system according to Embodiment 1. FIGS. 1B-1E illustrate that the VR eyepiece system provided in Embodiment 1 has desirable imaging quality.

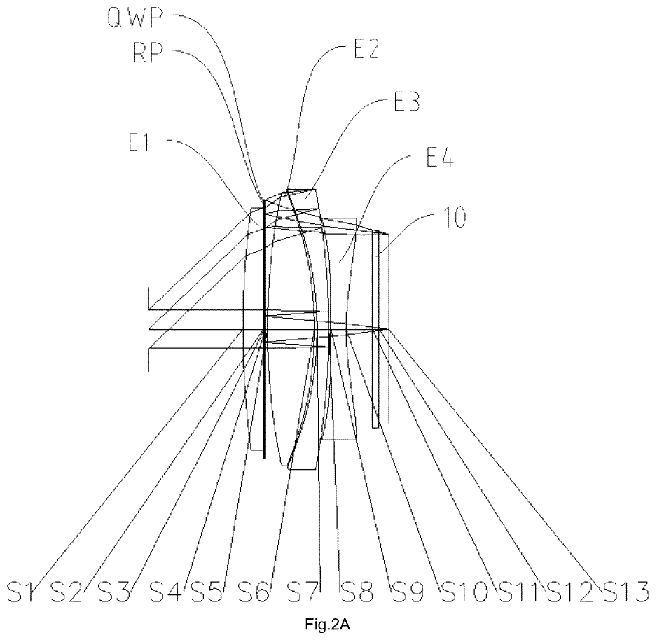

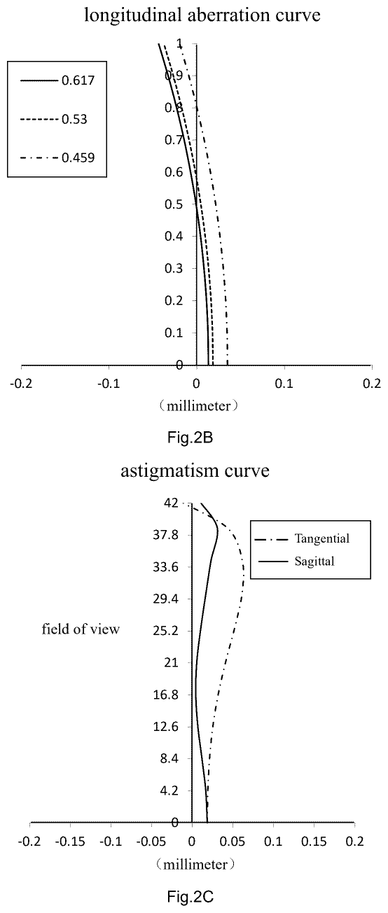

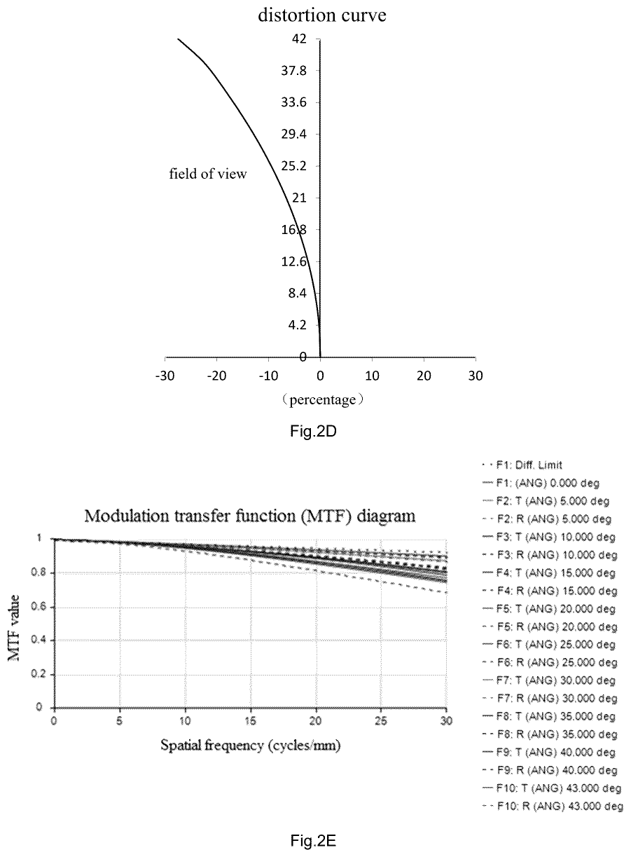

As shown in FIG. 2A, in Embodiment 2 of the disclosure, an optical camera lens includes a lens assembly, a polarizing reflective film RP, a quarter-wave plate QWP, a transflective film, and a display assembly 10. The lens assembly includes a first lens E1, a second lens E2, a third lens E3, and a fourth lens E4 that are coaxially arranged in sequence from an eye side to an image side. The polarizing reflective film RP is attached to the first lens E1. The quarter-wave plate QWP is attached to an image-side surface of the polarizing reflective film. The transflective film is attached to the third lens E3. The display assembly 10 is arranged on an image side of the fourth lens E4.

An eye-side surface and an image-side surface of the first lens E1 are a convex surface and a flat surface respectively, and the eye-side surface and the image-side surface of the first lens E1 are spherical surfaces. An eye-side surface and an image-side surface of the second lens E2 are convex surfaces, and the eye-side surface and the image-side surface of the second lens E2 are spherical surfaces. The third lens E3 has a negative refractive power, an eye-side surface and an image-side surface of the third lens E3 are a concave surface and a convex surface respectively, and the eye-side surface and the image-side surface of the third lens E3 are aspheric surfaces. An eye-side surface and an image-side surface of the fourth lens E4 are concave surfaces, and the eye-side surface and the image-side surface of the fourth lens E4 are aspheric surfaces.

Table 3 is a table of basic parameters of the lenses of the VR eyepiece system of Embodiment 2. The units of radius of curvature and thickness are millimeter (mm).

TABLE 3
table of basic parameters of lenses of VR eyepiece system of Embodiment 2

| | | | | | | | | | | | | Quadric |
|---|---|---|---|---|---|---|---|---|---|---|---|---|
| | Surface | Surface | | Radius of | | | | | | Refraction | Effective | constant |
| | number | type | | curvature | | Thickness | | Material | | mode | radius | K |
| Stop | | Spherical | | Infinite | | 10.0000 | | | | Refraction | 2.0000 | |
| surface | | | | | | | | | | | | |
| STO | | | | | | | | | | | | |
| Reflector | S1 | Spherical | R1 | 88.6174 | CT1 | 2.2000 | N1 | 1.74 | 44.80 | Refraction | 12.0990 | |
| REFL1 | | | | | | | V1 | | | | | |
| Polarizing | S2 | Spherical | R2 | Infinite | | 0.1100 | | 1.50 | 57.00 | Refraction | 12.5568 | |
| reflective | | | | | | | | | | | | |
| film RP | | | | | | | | | | | | |
| Quarter- | S3 | Spherical | | Infinite | | 0.1100 | | 1.50 | 57.00 | Refraction | 12.6004 | |
| wave | | | | | | | | | | | | |
| plate QWP | | | | | | | | | | | | |
| | S4 | Spherical | | Infinite | | 0.1999 | | | | Refraction | 12.6441 | |
| Reflector | S5 | Spherical | R3 | 67.8119 | CT2 | 5.0000 | N2 | 1.74 | 44.80 | Refraction | 13.7095 | |
| REFL2 | | | | | | | V2 | | | | | |
| Glue layer | S6 | Spherical | R4 | −35.8272 | | 0.2866 | | 1.50 | 57.00 | Refraction | 13.8843 | |
| (glue) | | | | | | | | | | | | |
| Reflector | S7 | Aspheric | R5 | −35.8272 | CT3 | 1.2500 | N3 | 1.85 | 23.60 | Refraction | 13.9035 | 2.4614 |
| REFL3 | | | | | | | V3 | | | | | |
| | S8 | Aspheric | R6 | −74.2924 | | 1.2500 | | 1.85 | 23.60 | Reflection | 14.5420 | 3.5698 |
| | S7 | Aspheric | R5 | −35.8272 | | 0.2866 | | 1.50 | 57.00 | Refraction | 14.1802 | 2.4614 |
| | S6 | Spherical | R4 | −35.8272 | | 5.0000 | | 1.74 | 44.80 | Refraction | 14.1733 | |
| | S5 | Spherical | R3 | 67.8119 | | 0.1999 | | | | Refraction | 14.1075 | |
| | S4 | Spherical | | Infinite | | 0.1100 | | 1.50 | 57.00 | Refraction | 13.4488 | |
| | S3 | Spherical | | Infinite | | 0.1100 | | 1.50 | 57.00 | Reflection | 13.4214 | |
| | S4 | Spherical | | Infinite | | 0.1999 | | | | Refraction | 13.3939 | |
| | S5 | Spherical | R3 | 67.8119 | CT2 | 5.0000 | | 1.74 | 44.80 | Refraction | 12.8361 | |
| | S6 | Spherical | R4 | −35.8272 | | 0.2866 | | 1.50 | 57.00 | Refraction | 12.3586 | |
| | S7 | Aspheric | R5 | −35.8272 | CT3 | 1.2500 | | 1.85 | 23.60 | Refraction | 12.3018 | 2.4614 |
| | S8 | Aspheric | R6 | −74.2924 | | 0.1997 | | | | Refraction | 11.6220 | 3.5698 |
| Reflector | S9 | Aspheric | R7 | 4715.6654 | CT4 | 1.6322 | N4 | 1.85 | 23.60 | Refraction | 11.5120 | 99.0000 |
| REFL4 | | | | | | | V4 | | | | | |
| | S10 | Aspheric | R8 | 28.9553 | | 2.8143 | | | | Refraction | 10.7990 | 1.6803 |
| | S11 | Spherical | | Infinite | | 0.7000 | | 1.52 | 6417 | Refraction | 10.2733 | |
| | S12 | Spherical | | Infinite | | 0.9972 | | | | Refraction | 10.1349 | |
| Imaging | S13 | Spherical | | Infinite | | 0.0000 | | | | Refraction | 9.8272 | |
| surface | | | | | | | | | | | | |
| IMG | | | | | | | | | | | | |

In Embodiment 2, the eye-side surfaces and the image-side surfaces of the third lens E3 and the fourth lens E4 are aspheric surfaces, and a surface type x of each aspheric lens may be defined by the following aspheric formula, which is not restrictive:

$$x = \frac{{ch}^{2}}{1 + \sqrt{1 - ( k + 1 ) {c}^{2} {h}^{2}}} + \sum {Aih}^{i}$$

Wherein, x is a vector height of a distance between the aspheric surface and a vertex of the aspheric surface when the aspheric surface is located at a position with the height h in the optical axis direction; c is a paraxial curvature of the aspheric surface, c=1/R (that is, that is, the paraxial curvature c is a reciprocal of radius of curvature R in Table 3 above; k is a conic coefficient; and Ai is a correction coefficient of the i-th order of the aspheric surface. Table 4 shows high-order term coefficients A4, A6, and A8 that may be configured for each of the aspheric lens surfaces S7-S10 in Embodiment 2.

TABLE 4
table of conic coefficients of aspheric lens surfaces
of VR eyepiece system of Embodiment 2

| Surface number | A4 | A6 | A8 |
|---|---|---|---|
| S7 | −1.502E−05 | 1.109E−07 | −2.435E−11 |
| S8 | −1.063E−06 | 1.481E−08 | −2.876E−12 |
| S9 | −6.938E−05 | 1.152E−08 | 7.411E−10 |
| S10 | −8.268E−05 | −6.120E−08 | 4.576E−10 |

FIG. 2B shows a longitudinal aberration curve of the VR eyepiece system according to Embodiment 2. FIG. 2C shows an astigmatism curve of the VR eyepiece system according to Embodiment 2. FIG. 2D shows a distortion curve of the VR eyepiece system according to Embodiment 2. FIG. 2E shows an MTF diagram of the VR eyepiece system according to Embodiment 2. FIGS. 2B-2E illustrate that the VR eyepiece system provided in Embodiment 2 has desirable imaging quality.

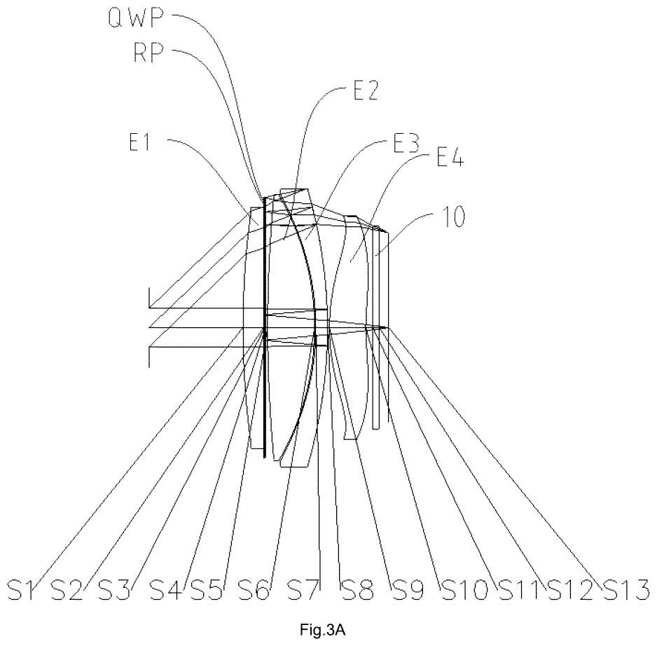

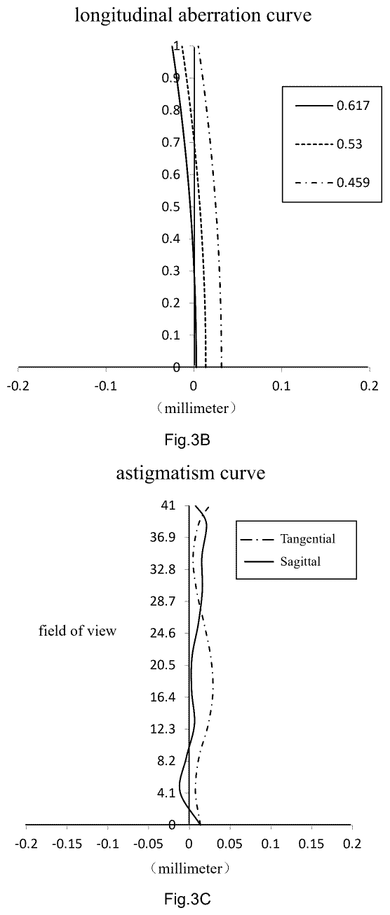

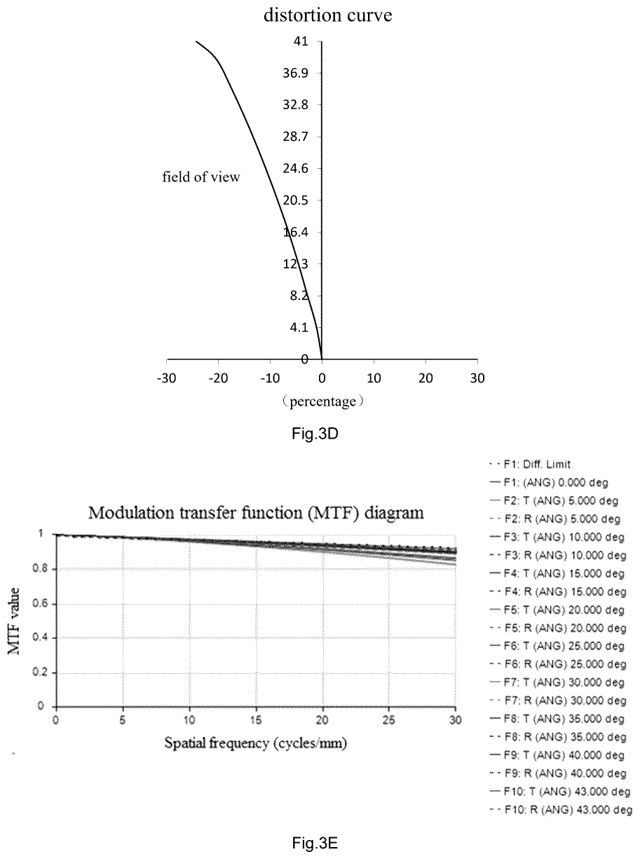

As shown in FIG. 3A, in Embodiment 3 of the disclosure, an optical camera lens includes a lens assembly, a polarizing reflective film RP, a quarter-wave plate QWP, a transflective film, and a display assembly 10. The lens assembly includes a first lens E1, a second lens E2, a third lens E3, and a fourth lens E4 that are coaxially arranged in sequence from an eye side to an image side. The polarizing reflective film RP is attached to the first lens E1. The quarter-wave plate QWP is attached to an image-side surface of a polarizing reflective film. The transflective film is attached to the third lens E3. The display assembly 10 is arranged on an image side of the fourth lens E4.

An eye-side surface and an image-side surface of the first lens E1 are a convex surface and a flat surface respectively, and the eye-side surface and the image-side surface of the first lens E1 are spherical surfaces. An eye-side surface and an image-side surface of the second lens E2 are convex surfaces, and the eye-side surface and the image-side surface of the second lens E2 are spherical surfaces. The third lens E3 has a negative refractive power, an eye-side surface and an image-side surface of the third lens E3 are a concave surface and a convex surface respectively, and the eye-side surface and the image-side surface of the third lens E3 are aspheric surfaces. An eye-side surface and an image-side surface of the fourth lens E4 are a convex surface and a concave surface respectively, and the eye-side surface and the image-side surface of the fourth lens E4 are aspheric surfaces.

Table 5 is a table of basic parameters of the lenses of the VR eyepiece system of Embodiment 3. The units of radius of curvature and thickness are millimeter (mm).

TABLE 5
table of basic parameters of lenses of VR eyepiece system of Embodiment 3

| | | | | | | | | | | | | Quadric |
|---|---|---|---|---|---|---|---|---|---|---|---|---|
| | Surface | Surface | | Radius of | | | | | | Refraction | Effective | constant |
| | number | type | | curvature | | Thickness | | Material | | mode | radius | K |
| Stop | | Spherical | | Infinite | | 10.0000 | | | | Refraction | 2.0000 | |
| surface | | | | | | | | | | | | |
| STO | | | | | | | | | | | | |
| Reflector | S1 | Spherical | R1 | 86.1556 | CT1 | 2.2000 | N1V1 | 1.85 | 23.60 | Refraction | 12.1247 | |
| REFL1 | | | | | | | | | | | | |
| Polarizing | S2 | Spherical | R2 | Infinite | | 0.1100 | | 1.50 | 57.00 | Refraction | 12.5266 | |
| reflective | | | | | | | | | | | | |
| film RP | | | | | | | | | | | | |
| Quarter- | S3 | Spherical | | Infinite | | 0.1100 | | 1.50 | 57.00 | \|Refraction | 12.5683 | |
| wave plate | | | | | | | | | | | | |
| QWP | | | | | | | | | | | | |
| | S4 | Spherical | | Infinite | | 0.1999 | | | | Refraction | 12.6100 | |
| Reflector | S5 | Spherical | R3 | 140.3390 | CT2 | 5.0000 | N2V2 | 1.49 | 70.00 | Refraction | 13.1232 | |
| REFL2 | | | | | | | | | | | | |
| Glue layer | S6 | Spherical | R4 | 26.8179 | | 0.1199 | | 1.50 | 57.00 | Refraction | 13.3953 | |
| (glue) | | | | | | | | | | | | |
| Reflector | S7 | Aspheric | R5 | 26.8179 | CT3 | 12500 | N3V3 | 1.80 | 28.85 | Refraction | 13.4477 | 1.3916 |
| REFL3 | | | | | | | | | | | | |
| | S8 | Aspheric | R6 | 48.5102 | | 1.2500 | | 1.80 | 28.85 | Reflection | 14.4472 | −0.1791 |
| | S7 | Aspheric | R5 | 26.8179 | | 0.1199 | | 1.50 | 57.00 | Refraction | 13.8440 | 1.3916 |
| | S6 | Spherical | R4 | 26.8179 | | 5.0000 | | 1.49 | 70.00 | Refraction | 13.8184 | |
| | S5 | Spherical | R3 | 140.3390 | | 0.1999 | | | | Refraction | 13.7515 | |
| | S4 | Spherical | | Infinite | | 0.1100 | | 1.50 | 57.00 | Refraction | 13.5241 | |
| | S3 | Spherical | | Infinite | | 0.1100 | | 1.50 | 57.00 | Reflection | 13.5054 | |
| | S4 | Spherical | | Infinite | | 0.1999 | | | | Refraction | 13.4867 | |
| | S5 | Spherical | R3 | 140.3390 | CT2 | 5.0000 | | 1.49 | 70.00 | Refraction | 13.2714 | |
| | S6 | Spherical | R4 | 26.8179 | | 0.1199 | | 1.50 | 57.00 | Refraction | 13.0736 | |
| | S7 | Aspheric | R5 | 26.8179 | CT3 | 1.2500 | | 1.80 | 28.85 | Refraction | 13.0367 | 1.3916 |
| | S8 | Aspheric | R6 | 48.5102 | | 0.1994 | | | | Refraction | 12.8506 | −0.1791 |
| Reflector | S9 | Aspheric | R7 | 18.6240 | CT4 | 3.8589 | N4V4 | 1.49 | 70.00 | Refraction | 11.6109 | −20.2610 |
| REFL4 | | | | | | | | | | | | |
| | S10 | Aspheric | R8 | 16.3211 | | 0.7547 | | | | Refraction | 11.4714 | −99.0000 |
| | S11 | Spherical | | Infinite | | 0.7000 | | 1.52 | 64.17 | Refraction | 10.5733 | |
| | s12 | Spherical | | Infinite | | 0.9972 | | | | Refraction | 10.3454 | |
| Imaging | S13 | Spherical | | Infinite | | 0.0000 | | | | Refraction | 9.8172 | |
| surface | | | | | | | | | | | | |
| IMG | | | | | | | | | | | | |

In Embodiment 3, of the eye-side surfaces and the image-side surfaces of the third lens E3 and the fourth lens E4 are aspheric surfaces, and a surface type x of each aspheric lens may be defined by the following aspheric formula, which is not restrictive:

$$x = \frac{{ch}^{2}}{1 + \sqrt{1 - ( k + 1 ) {c}^{2} {h}^{2}}} + \sum {Aih}^{i}$$

Wherein, x is a vector height of a distance between the aspheric surface and a vertex of the aspheric surface when the aspheric surface is located at a position with the height h in the optical axis direction; c is a paraxial curvature of the aspheric surface, c=1/R (that is, that is, the paraxial curvature c is a reciprocal of radius of curvature R in Table 5 above; k is a conic coefficient; and Ai is a correction coefficient of the i-th order of the aspheric surface. Table 6 shows high-order term coefficients A4, A6, and A8 that may be configured for each of the aspheric lens surfaces S7-S10 in Embodiment 3.

TABLE 6
table of conic coefficients of aspheric lens surfaces
of VR eyepiece system of Embodiment 3

| Surface number | A4 | A6 | A8 |
|---|---|---|---|
| S7 | 3.720E−07 | 1.087E−07 | −4.585E−11 |
| S8 | −6.714E−07 | 1.738E−08 | −3.612E−11 |
| S9 | 1.679E−04 | −1.673E−06 | 2.174E−09 |
| S10 | −2.134E−04 | 1.457E−06 | −5.196E−09 |

FIG. 3B shows a longitudinal aberration curve of the VR eyepiece system according to Embodiment 3. FIG. 3C shows an astigmatism curve of the VR eyepiece system according to Embodiment 3. FIG. 3D shows a distortion curve of the VR eyepiece system according to Embodiment 3. FIG. 3E shows an MTF diagram of the VR eyepiece system according to Embodiment 3. FIGS. 3B-3E illustrate that the VR eyepiece system provided in Embodiment 3 has desirable imaging quality.

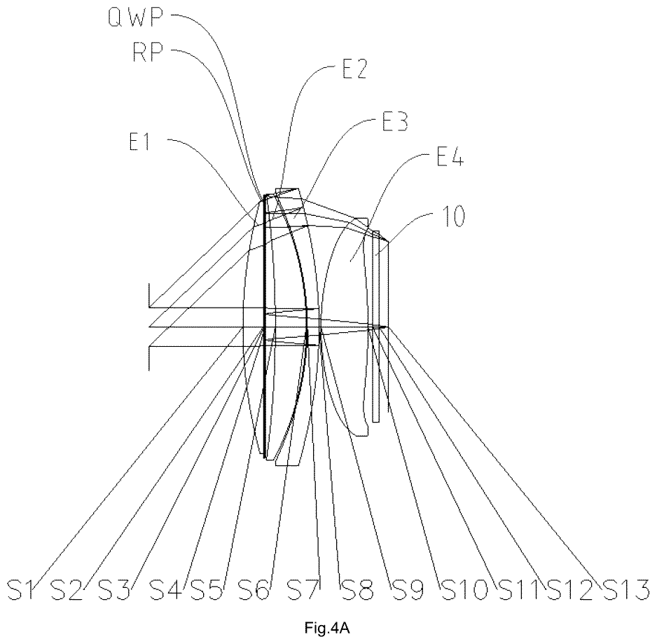

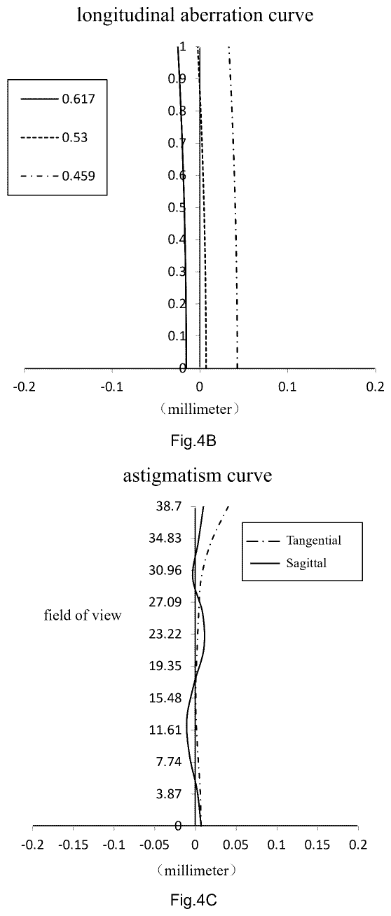

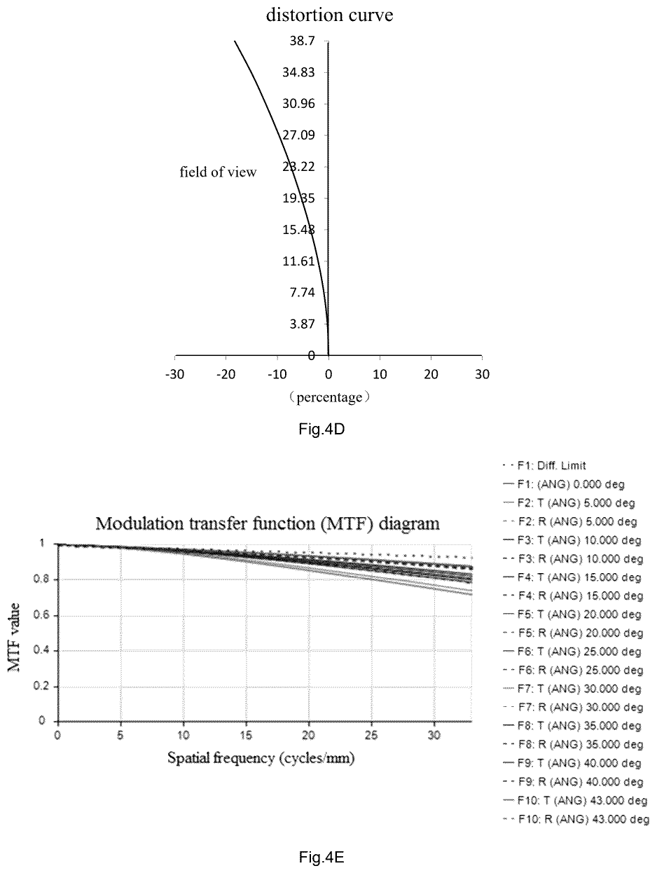

As shown in FIG. 4A, in Embodiment 4 of the disclosure, an optical camera lens includes a lens assembly, a polarizing reflective film RP, a quarter-wave plate QWP, a transflective film, and a display assembly 10. The lens assembly includes a first lens E1, a second lens E2, a third lens E3, and a fourth lens E4 that are coaxially arranged in sequence from an eye side to an image side. The polarizing reflective film RP is attached to the first lens E1. The quarter-wave plate QWP is attached to an image-side surface of a polarizing reflective film. The transflective film is attached to the third lens E3. The display assembly 10 is arranged on an image side of the fourth lens E4.

An eye-side surface and an image-side surface of the first lens E1 are a convex surface and a flat surface respectively, and the eye-side surface and the image-side surface of the first lens E1 are spherical surfaces. An eye-side surface and an image-side surface of the second lens E2 are a concave surface and a convex surface respectively, and the eye-side surface and the image-side surface of the second lens E2 are spherical surfaces. The third lens E3 has a negative refractive power, an eye-side surface and an image-side surface of the third lens E3 are a concave surface and a convex surface respectively, and the eye-side surface and the image-side surface of the third lens E3 are aspheric surfaces. An eye-side surface and an image-side surface of the fourth lens E4 are convex surfaces, and the eye-side surface and the image-side surface of the fourth lens E4 are aspheric surfaces.

Table 7 is a table of basic parameters of the lenses of the VR eyepiece system of Embodiment 4. The units of radius of curvature and thickness are millimeter (mm).

TABLE 7
table of basic parameters of lenses of VR eyepiece system of Embodiment 4

| | | | | | | | | | | | | Quadric |
|---|---|---|---|---|---|---|---|---|---|---|---|---|
| | Surface | Surface | | Radius of | | | | | | Refraction | Effective | constant |
| | number | type | | curvature | | Thickness | | Material | | mode | radius | K |
| Stop | | Spherical | | Infinite | | 10.0000 | | | | Refraction | 2.0000 | |
| surface | | | | | | | | | | | | |
| STO | | | | | | | | | | | | |
| Reflector | S1 | Spherical | R1 | 47.9351 | CT1 | 2.1700 | N1V1 | 1.62 | 60.00 | Refraction | 13.0005 | |
| REFL1 | | | | | | | | | | | | |
| Polarizing | S2 | Spherical | R2 | Infinite | | 0.1100 | | 1.50 | 57.00 | Refraction | 13.1078 | |
| reflective | | | | | | | | | | | | |
| film RP | | | | | | | | | | | | |
| Quarter- | S3 | Spherical | | Infinite | | 0.1100 | | 1.50 | 57.00 | Refraction | 13.1422 | |
| wave plate | | | | | | | | | | | | |
| QWP | | | | | | | | | | | | |
| | S4 | Spherical | | Infinite | | 1.0632 | | | | Refraction | 13.1766 | |
| Reflector | S5 | Spherical | R3 | 101.0000 | CT2 | 3.3000 | N2V2 | 1.67 | 51.50 | Refraction | 13.2707 | |
| REFL2 | | | | | | | | | | | | |
| Glue layer | S6 | Spherical | R4 | −28.8542 | | 0.1000 | | 1.50 | 57.00 | Refraction | 13.5428 | |
| (glue) | | | | | | | | | | | | |
| Reflector | S7 | Aspheric | R5 | −28.8542 | CT3 | 1.2500 | N3V3 | 1.85 | 23.60 | Refraction | 13.6235 | −0.0334 |
| REFL3 | | | | | | | | | | | | |
| | S8 | Aspheric | R6 | −44.8348 | | 1.2500 | | 1.85 | 23.60 | Reflection | 14.4045 | −1.4998 |
| | S7 | Aspheric | R5 | −28.8542 | | 0.1000 | | 1.50 | 57.00 | Refraction | 13.8737 | −0.0334 |
| | S6 | Spherical | R4 | −28.8542 | | 3.3000 | | 1.67 | 51.50 | Refraction | 13.8234 | |
| | S5 | Spherical | R3 | 101.0000 | | 1.0632 | | | | Refraction | 13.6769 | |
| | S4 | Spherical | | Infinite | | 0.1100 | | 1.50 | 57.00 | Refraction | 13.6426 | |
| | S3 | Spherical | | Infinite | | 0.1100 | | 1.50 | 57.00 | Reflection | 13.6240 | |
| | S4 | Spherical | | Infinite | | 1.0632 | | | | Refraction | 13.6055 | |
| | S5 | Spherical | R3 | 101.0000 | CT2 | 3.3000 | | 1.67 | 51.50 | Refraction | 13.5673 | |
| | S6 | Spherical | R4 | −28.8542 | | 0.1000 | | 1.50 | 57.00 | Refraction | 13.4868 | |
| | S7 | Aspheric | R5 | −28.8542 | CT3 | 1.2500 | | 1.85 | 23.60 | Refraction | 13.4340 | −0.0334 |
| | S8 | Aspheric | R6 | −44.8348 | | 0.1995 | | | | Refraction | 133123 | −1.4998 |
| Reflector | S9 | Aspheric | R7 | 26.7415 | CT4 | 5.0000 | N4V4 | 1.62 | 60.00 | Refraction | 11.2677 | 4.1372 |
| REFL4 | | | | | | | | | | | | |
| | S10 | Aspheric | R8 | −51.9596 | | 0.5001 | | | | Refraction | 10.3216 | −40.3201 |
| | S11 | Spherical | | Infinite | | 0.7000 | | 1.52 | 64.17 | Refraction | 9.9225 | |
| | S12 | Spherical | | Infinite | | 0.9972 | | | | Refraction | 9.6072 | |
| Imaging | S13 | Spherical | | Infinite | | 0.0000 | | | | Refraction | 8.8400 | |
| surface | | | | | | | | | | | | |
| IMG | | | | | | | | | | | | |

In Embodiment 4, the eye-side surfaces and the image-side surfaces of the third lens E3 and the fourth lens E4 are aspheric surfaces, and a surface type x of each aspheric lens may be defined by the following aspheric formula, which is not restrictive:

$$x = \frac{{ch}^{2}}{1 + \sqrt{1 - ( k + 1 ) {c}^{2} {h}^{2}}} + \sum {Aih}^{i}$$

Wherein, x is a vector height of a distance between the aspheric surface and a vertex of the aspheric surface when the aspheric surface is located at a position with the height h in the optical axis direction; c is a paraxial curvature of the aspheric surface, c=1/R (that is, that is, the paraxial curvature c is a reciprocal of radius of curvature R in Table 7 above; k is a conic coefficient; and Ai is a correction coefficient of the i-th order of the aspheric surface. Table 8 shows high-order term coefficients A4, A6, and A8 that may be configured for each of the aspheric lens surfaces S7-S10 in Embodiment 4.

TABLE 8
table of conic coefficients of aspheric lens surfaces
of VR eyepiece system of Embodiment 4

| Surface number | A4 | A6 | A8 |
|---|---|---|---|
| S7 | −8.022E−07 | 2.984E−08 | 2.123E−11 |
| S8 | 1.326E−06 | 3.888E−09 | 1999E−12 |
| S9 | 2.642E−05 | −8.866E−07 | 5.384E−09 |
| S10 | −9.599E−06 | −2.476E−07 | 9.300E−09 |

FIG. 4B shows a longitudinal aberration curve of the VR eyepiece system according to Embodiment 4. FIG. 4C shows an astigmatism curve of the VR eyepiece system according to Embodiment 4. FIG. 4D shows a distortion curve of the VR eyepiece system according to Embodiment 4. FIG. 4E shows an MTF diagram of the VR eyepiece system according to Embodiment 4. FIGS. 4B-4E illustrate that the VR eyepiece system provided in Embodiment 4 has desirable imaging quality.

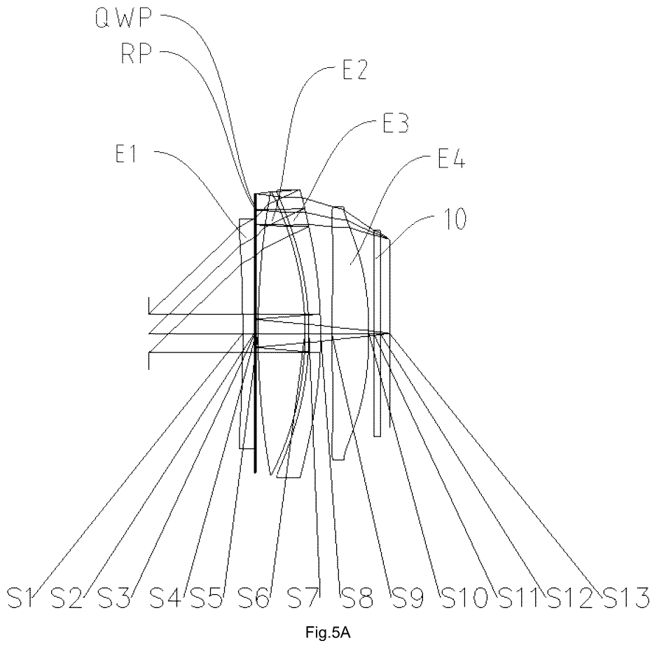

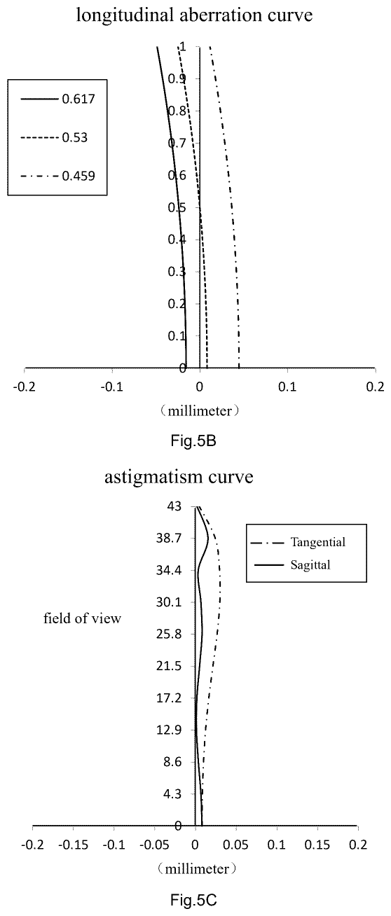

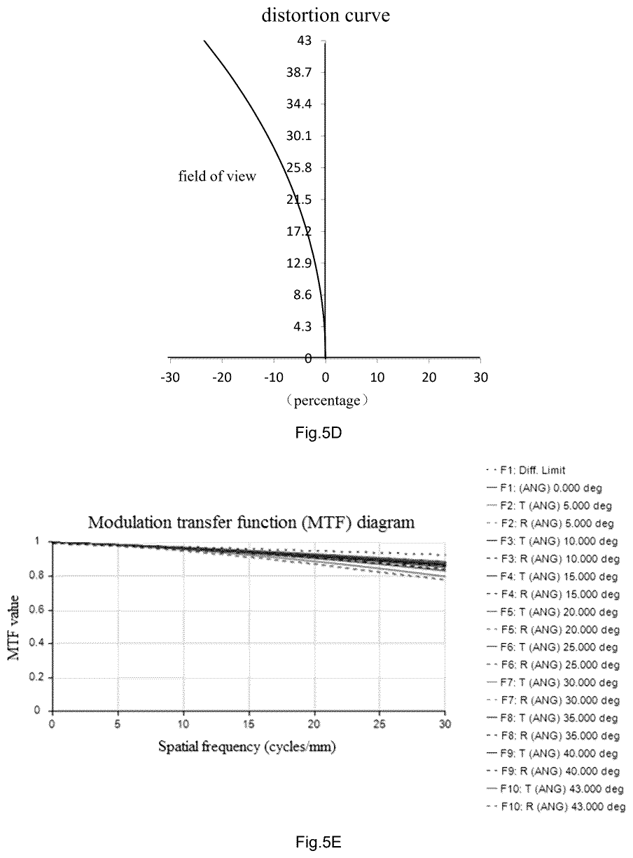

As shown in FIG. 5A, in Embodiment 5 of the disclosure, an optical camera lens includes a lens assembly, a polarizing reflective film RP, a quarter-wave plate QWP, a transflective film, and a display assembly 10. The lens assembly includes a first lens E1, a second lens E2, a third lens E3, and a fourth lens E4 that are coaxially arranged in sequence from an eye side to an image side. The polarizing reflective film RP is attached to the first lens E1. The quarter-wave plate QWP is attached to an image-side surface of a polarizing reflective film. The transflective film is attached to the third lens E3. The display assembly 10 is arranged on an image side of the fourth lens E4.

An eye-side surface and an image-side surface of the first lens E1 are a concave surface and a flat surface respectively, and the eye-side surface and the image-side surface of the first lens E1 are spherical surfaces. An eye-side surface and an image-side surface of the second lens E2 are convex surfaces, and the eye-side surface and the image-side surface of the second lens E2 are spherical surfaces. The third lens E3 has a negative refractive power, an eye-side surface and an image-side surface of the third lens E3 are a concave surface and a convex surface respectively, and the eye-side surface and the image-side surface of the third lens E3 are aspheric surfaces. An eye-side surface and an image-side surface of the fourth lens E4 are convex surfaces, and the eye-side surface and the image-side surface of the fourth lens E4 are aspheric surfaces.

Table 9 is a table of basic parameters of the lenses of the VR eyepiece system of Embodiment 5. The units of radius of curvature and thickness are millimeter (mm).

TABLE 9
table of basic parameters of lenses of VR eyepiece system of Embodiment 5

| | | | | | | | | | | | | Quadric |
|---|---|---|---|---|---|---|---|---|---|---|---|---|
| | Surface | Surface | | Radius of | | | | | | Refraction | Effective | constant |
| | number | type | | curvature | | Thickness | | Material | | mode | radius | K |
| Stop | | Spherical | | Infinite | | 10 | | | | Refraction | 2 | |
| surface | | | | | | | | | | | | |
| STO | | | | | | | | | | | | |
| Reflector | S1 | Spherical | R1 | 150.0000 | CT1 | 1.2000 | N1V1 | 1.49 | 70.00 | Refraction | 10.9518 | |
| REFL1 | | | | | | | | | | | | |
| Polarizing | S2 | Spherical | R2 | Infinite | | 0.1100 | | 1.50 | 57.00 | Refraction | 11.8413 | |
| reflective | | | | | | | | | | | | |
| film RP | | | | | | | | | | | | |
| Quarter- | S3 | Spherical | | Infinite | | 0.1100 | | 1.50 | 57.00 | Refraction | 11.9017 | |
| wave plate | | | | | | | | | | | | |
| QWP | | | | | | | | | | | | |
| | S4 | Spherical | | Infinite | | 0.1999 | | | | Refraction | 11.9622 | |
| Reflector | S5 | Spherical | R3 | 82.0363 | CT2 | 5.0000 | N2V2 | 1.49 | 70.00 | Refraction | 13.3124 | |
| REFL2 | | | | | | | | | | | | |
| Glue layer | S6 | Spherical | R4 | −31.5928 | | 0.4000 | | 1.50 | 57.00 | Refraction | 13.6743 | |
| (glue) | | | | | | | | | | | | |
| Reflector | S7 | Aspheric | R5 | −31.5928 | CT3 | 1.2500 | N3V3 | 1.80 | 29.72 | Refraction | 13.8672 | 0.5641 |
| REFL3 | | | | | | | | | | | | |
| | S8 | Aspheric | R6 | −47.7045 | | 1.2500 | | 1.80 | 29.72 | Reflection | 14.8337 | −1.1263 |
| | S7 | Aspheric | R5 | −31.5928 | | 0.4000 | | 1.50 | 57.00 | Refraction | 14.5989 | 0.5641 |
| | S6 | Spherical | R4 | −31.5928 | | 5.0000 | | 1.49 | 70.00 | Refraction | 14.5851 | |
| | S5 | Spherical | R3 | 82.0363 | | 0.1999 | | | | Refraction | 14.5825 | |
| | S4 | Spherical | | Infinite | | 0.1100 | | 1.50 | 57.00 | Refraction | 14.4002 | |
| | S3 | Spherical | | Infinite | | 0.1100 | | 1.50 | 57.00 | Reflection | 14.3914 | |
| | S4 | Spherical | | Infinite | | 0.1999 | | | | Refraction | 14.3826 | |
| | S5 | Spherical | R3 | 82.0363 | CT2 | 5.0000 | | 1.49 | 70.00 | Refraction | 14.2083 | |
| | S6 | Spherical | R4 | −31.5928 | | 0.4000 | | 1.50 | 57.00 | Refraction | 14.1508 | |
| | S7 | Aspheric | R5 | −31.5928 | CT3 | 1.2500 | | 1.80 | 29.72 | Refraction | 14.0752 | 0.5641 |
| | S8 | Aspheric | R6 | −47.7045 | | 1.1816 | | | | Refraction | 13.9942 | −1.1263 |
| Reflector | S9 | Aspheric | R7 | 92.9461 | CT4 | 3.9511 | N4V4 | 1.50 | 68.50 | Refraction | 13.0531 | 1.7264 |
| REFL4 | | | | | | | | | | | | |
| | S10 | Aspheric | R8 | −37.3275 | | 0.4998 | | | | Refraction | 12.7532 | 5.0531 |
| | S11 | Spherical | | Infinite | | 0.7000 | | 1.52 | 64.17 | Refraction | 10.6342 | |
| | S12 | Spherical | | Infinite | | 0.9972 | | | | Refraction | 10.3599 | |
| Imaging | S13 | Spherical | | Infinite | | 0.0000 | | | | Refraction | 9.6954 | |
| surface | | | | | | | | | | | | |
| IMG | | | | | | | | | | | | |

In Embodiment 5, the eye-side surfaces and the image-side surfaces of the third lens E3 and the fourth lens E4 are aspheric surfaces, and a surface type x of each aspheric lens may be defined by the following aspheric formula, which is not restrictive:

$$x = \frac{{ch}^{2}}{1 + \sqrt{1 - ( k + 1 ) {c}^{2} {h}^{2}}} + \sum {Aih}^{i}$$

Wherein, x is a vector height of a distance between the aspheric surface and a vertex of the aspheric surface when the aspheric surface is located at a position with the height h in the optical axis direction; c is a paraxial curvature of the aspheric surface, c=1/R (that is, that is, the paraxial curvature c is a reciprocal of radius of curvature R in Table 9 above; k is a conic coefficient; and Ai is a correction coefficient of the i-th order of the aspheric surface. Table 10 shows high-order term coefficients A4, A6, and A8 that may be configured for each of the aspheric lens surfaces S7-S10 in Embodiment 5.

TABLE 10
table of conic coefficients of aspheric lens surfaces
of VR eyepiece system of Embodiment 5

| Surface number | A4 | A6 | A8 |
|---|---|---|---|
| S7 | 5.062E−07 | 3.388E−08 | −2.234E−11 |
| S8 | 4.294E−07 | 7.789E−09 | 4.404E−12 |
| S9 | −3.805E−05 | −2.873E−07 | 2.022E−09 |
| S10 | −3.020E−05 | −2.826E−09 | 1.368E−09 |

FIG. 5B shows a longitudinal aberration curve of the VR eyepiece system according to Embodiment 5. FIG. 5C shows an astigmatism curve of the VR eyepiece system according to Embodiment 5. FIG. 5D shows a distortion curve of the VR eyepiece system according to Embodiment 5. FIG. 5E shows an MTF diagram of the VR eyepiece system according to Embodiment 5. FIGS. 5B-5E illustrate that the VR eyepiece system provided in Embodiment 5 has desirable imaging quality.

Optical parameters of the VR eyepiece systems of Embodiment 1 to Embodiment 5 are shown in the following table.

| Embodiment | | | | | |
|---|---|---|---|---|---|
| parameter | 1 | 2 | 3 | 4 | 5 |
| TTL | 15.50 | 15.50 | 15.50 | 15.50 | 15.60 |
| ED | 10.00 | 10.00 | 10.00 | 10.00 | 10.00 |
| IMGh | 9.16 | 9.82 | 9.81 | 8.83 | 9.69 |
| SEMI-FOV | 43.00 | 42.00 | 41.00 | 38.70 | 43.00 |
| FNO | 3.11 | 3.63 | 3.47 | 3.07 | 3.39 |
| f | 12.46 | 14.53 | 13.90 | 12.28 | 13.57 |
| f1 | 164.17 | 206.97 | 186.53 | 124.81 | −456.18 |
| f2 | 1692.35 | 85.00 | 499.83 | −2696.27 | 270.11 |
| f3 | −2637 | −45.95 | −28.42 | −26.07 | −27.12 |
| f4 | 27.54 | −33.52 | −600.00 | 29.02 | 53.32 |

The VR eyepiece systems of Embodiment 1 to Embodiment 5 satisfy the following conditional expression.

| Conditional | | | | | |
|---|---|---|---|---|---|
| expression/Embodiment | | | | | |
| combination | 1 | 2 | 3 | 4 | 5 |
| TTL•tan(SEMI-FOV)/IMGh | 1.58 | 1.42 | 1.37 | 1.41 | 1.50 |
| f/IMGh | 1.36 | 1.48 | 1.42 | 1.39 | 1.40 |
| f1/f2 | 0.10 | 2.43 | 0.37 | −0.05 | −1.69 |
| f3/f4 | −0.96 | 1.37 | 0.05 | −0.90 | −0.51 |
| V2/V3 | 2.54 | 1.90 | 2.43 | 2.18 | 2.36 |
| (CT2 + CTg + CT3)/CT1 | 2.57 | 2.97 | 2.90 | 2.14 | 5.54 |
| (CT4•N4)/BFL | 3.40 | 0.67 | 2.34 | 3.69 | 2.71 |
| FNO/TAN(SEMI-FOV) | 3.34 | 4.03 | 4.00 | 3.83 | 3.64 |
| IMGh/DT42 | 0.86 | 0.91 | 0.86 | 0.86 | 0.76 |
| DT11/EPD | 3.06 | 3.02 | 3.03 | 3.25 | 2.74 |
| TD/ED | 1.33 | 1.10 | 1.30 | 1.33 | 1.34 |

All technical features in the above embodiments can be combined with one another randomly. In order to make the description concise, not all possible combinations of all the technical features in the above embodiments are described. However, as long as there is no contradiction between the combinations of these technical features, the combinations should be deemed as falling within the scope of the description.

The above embodiments only express several embodiments of the disclosure, and their description is specific and detailed, but should not be interpreted as limiting the scope of the disclosure. It should be noted that those of ordinary skill in the art can also make several variations and improvements without departing from the concept of the disclosure. These variations and improvements should fall within the scope of protection of the disclosure. Therefore, the scope of protection of the disclosure should be defined by the appended claims.

### REFERENCE NUMERALS

10 display assembly
E1 first lens
E2 second lens
E3 third lens
E4 fourth lens
RP polarizing reflective film
QWP quarter-wave plate

What is claimed is:

1. A virtual reality (VR) eyepiece system, comprising:
a lens assembly, wherein the lens assembly comprises a first lens, a second lens, a third lens, and a fourth lens that are coaxially arranged in sequence from an eye side to an image side; an image-side surface of the first lens is a flat surface, and an eye-side surface and the image-side surface of the first lens are spherical surfaces; an image-side surface of the second lens is a convex surface, and an eye-side surface and the image-side surface of the second lens are spherical surfaces; the third lens has a negative refractive power, an eye-side surface and an image-side surface of the third lens are a concave surface and a convex surface respectively, and the eye-side surface and the image-side surface of the third lens are aspheric surfaces; and an eye-side surface and an image-side surface of the fourth lens are aspheric surfaces;
a polarizing reflective film, wherein the polarizing reflective film is attached to the image-side surface of the first lens;
a quarter-wave plate, wherein the quarter-wave plate is attached to an image-side surface of the polarizing reflective film;
a transflective film, wherein the transflective film is attached to the image-side surface of the third lens; and
a display assembly, wherein the display assembly is arranged on the image-side surface of the fourth lens;
the VR eyepiece system satisfies the following conditional expression:
$$1.35 < TTL \cdot tan ( SEMI - FOV ) / IMGh < 1.6 ;$$
TTL is an on-axis distance from the eye-side surface of the first lens to the display assembly, SEMI-FOV is a semi-field of view of the VR eyepiece system, and IMGh is a half of a diagonal length of an effective pixel region on an imaging surface of the VR eyepiece system.

2. The VR eyepiece system according to claim 1, wherein the VR eyepiece system satisfies the following conditional expression:
$$1.35 < f / IMGh < 1.5 ;$$
f is an effective focal length of the VR eyepiece system, and IMGh is the half of the diagonal length of the effective pixel region on the imaging surface of the VR eyepiece system.

3. The VR eyepiece system according to claim 1, wherein the VR eyepiece system satisfies the following conditional expression:
$$- 2 < f 1 / f 2 < 2.5 ;$$
f1 is an effective focal length of the first lens, and f2 is an effective focal length of the second lens.

4. The VR eyepiece system according to claim 1, wherein the VR eyepiece system satisfies the following conditional expression:
$$- 1 < f 3 / f 4 < 1.4 ;$$
f3 is an effective focal length of the third lens, and f4 is an effective focal length of the fourth lens.

5. The VR eyepiece system according to claim 1, wherein the lens assembly further comprises a glue layer having a refractive index, and the glue layer is arranged between the second lens and the third lens, so as to glue the second lens and the third lens together.

6. The VR eyepiece system according to claim 5, wherein the VR eyepiece system satisfies the following conditional expression:
N polarizing reflective film RP=N quarter-wave plate QWP=Ng;
N polarizing reflective film RP is a refractive index of the polarizing reflective film, N quarter-wave plate QWP is a refractive index of the quarter-wave plate, and Ng is the refractive index of the glue layer.

7. The VR eyepiece system according to claim 5, wherein the VR eyepiece system satisfies the following conditional expression:
$$1.9 \leq V 2 / V 3 < 2.6 ;$$
V2 is an Abbe number of the second lens, and V3 is an Abbe number of the third lens.

8. The VR eyepiece system according to claim 5, wherein the VR eyepiece system satisfies the following conditional expression:
$$2.1 < ( CT 2 + CTg + CT 3 ) / CT 1 < 5.6 ;$$
CT1 is a center thickness of the first lens, CT2 is a center thickness of the second lens, CTg is a center thickness of the glue layer, and CT3 is a center thickness of the third lens.

9. The VR eyepiece system according to claim 1, wherein the VR eyepiece system satisfies the following conditional expression:
$$0.6 < ( CT 4 \cdot N 4 ) / BFL < 3.7 ;$$
CT4 is a center thickness of the fourth lens, N4 is a refractive index of the fourth lens, and BFL is an on-axis distance from the image-side surface of the fourth lens to a display screen.

10. The VR eyepiece system according to claim 1, wherein the VR eyepiece system satisfies the following conditional expression:
$$3.3 < FNO / TAN ( SEMI - FOV ) < 4.1 ;$$
SEMI-FOV is the semi-field of view of the VR eyepiece system, and FNO is a numerical aperture of the VR eyepiece system.

11. The VR eyepiece system according to claim 1, wherein the VR eyepiece system satisfies the following conditional expression:
$$0.75 < IMGh / DT 42 < 0.95 ;$$
IMGh is the half of the diagonal length of the effective pixel region on the imaging surface of the VR eyepiece system, and DT42 is an effective radius of the image-side surface of the fourth lens.

12. The VR eyepiece system according to claim 1, wherein the VR eyepiece system satisfies the following conditional expression:
$$2.7 < DT 11 / EPD < 3.3 ;$$
DT11 is an effective radius of the eye-side surface of the first lens, and EPD is an entrance pupil diameter of the VR eyepiece system.

13. The VR eyepiece system according to claim 1, wherein the VR eyepiece system satisfies the following conditional expression:
$$1.1 \leq TD / ED < 1.35 ;$$
TD is an on-axis distance from the eye-side surface of the first lens to the image-side surface of the fourth lens, and ED is an on-axis distance from an eye to the eye-side surface of the first lens.
